(19) United States
(12) Patent Application Publication
(10) Pub. No.: US 2020/0193502 A1
(43) Pub. Date: Jun. 18, 2020

(54) RECOMMENDATION ENGINE FOR CLOTHING SELECTION AND WARDROBE MANAGEMENT

(71) Applicant: Samuel Smith, San Mateo, CA (US)

(72) Inventor: Samuel Smith, San Mateo, CA (US)

(21) Appl. No.: 16/264,631

(22) Filed: Jan. 31, 2019

Related U.S. Application Data
(60) Provisional application No. 62/627,197, filed on Feb. 7, 2018.

(51) Int. Cl. G06Q 30/06; G06N 20/00

(52) U.S. Cl. CPC G06Q 30/0631; G06N 20/00; G06Q 30/0643

(57) ABSTRACT

A system is disclosed that makes recommendations on what to wear or purchase based on what articles of clothing make up the user's wardrobe and trends on what they wear. Additionally, the system can access other users with similar wardrobes, in aggregate, to make suggestions on what to wear or purchase to follow current styles or trends.

### BACKGROUND

The present the preferred system relates to wardrobe suggestion.

Many people have trouble deciding what outfit they should wear from the clothing available to them. They also have trouble deciding which articles of clothing to purchase in order to build out their wardrobe for a particular style that is appealing to them.

However, dressing well is difficult:
20%—average amount of clothing utilized from a wardrobe
10% of people are regularly late for work looking for an outfit
20 mins—average time spent daily, deciding what to wear to work
28% of adults have been so frustrated trying to find something to wear that they throw their clothing

Clothing is purchased through a wide variety of mechanisms. Many people purchase clothing at department stores and specialty retailers. Others purchase clothing through on-line retailers. Still others purchase custom made clothing through tailors. In all scenarios it is important for customer satisfaction that the clothing purchased is the correct size. In some cases the purchaser has a chance to try on the clothing for proper fit. But in many of the purchase situations the purchaser is remote from the clothing and is using their measurements to select the best size. In many countries, clothing is the most popular online purchase. Up to half of the clothes purchased online are returned. Many of the returns are due to poor fit. This results in reduced margins for the retailers and dissatisfied purchasers. There is evidence that the online market for clothing would increase significantly if the customers could be assured of a better fit.

The likelihood of a better fit, where the clothing is not available to try on such as in an online purchase, may be increased with more measurements of the purchaser's body. This approach has been used with many systems that use special clothing designed just for taking measurements (U.S. Pat. No. 5,680,314), electronic imaging or scanning of a person's body to measure dimensions (U.S. Pat. No. 8,359,247), combinations of scanning and databases to fill in missing measurement data (U.S. Pat. No. 7,623,938). Feedback from purchasers however is that they are reluctant to provide more measurement information. This is attributed to both a desire for privacy and to the fact that the reason they are purchasing online is to save time in the purchasing process. Measurements take time.

There are also manufacturing variations in clothing sizes. In many cases the size of clothing will vary from batch to batch and from one manufacturer to the next. A size 8 dress from one manufacturer is not always equivalent as that from another. Additionally, clothing fit is not strictly a measurement issue. Different styles of clothing fit differently both from a comfort factor and from an aesthetic factor. Some clothing styles look and/or feel better when fit snugly while for other styles a looser fit will result in fewer returns. There is also a factor of preferences of the purchaser. Each person has their own preferences as to how clothing should fit. When it comes to returns there are also user behavioral issues. Some people are much more likely to return a purchased article than others.

### SUMMARY

In a first aspect, a system makes recommendations on what to wear or purchase based on what articles of clothing make up the user's wardrobe and trends on what they wear. Additionally, the system can access other users with similar wardrobes, in aggregate, to make suggestions on what to wear or purchase to follow current styles or trends. The major modules include
Digitize: User enters new clothing into the system
Analyze: Machine learning logs detail and generates associations
Realize: The system suggests outfits for the day based on user preferences/patterns

In a second aspect, the system includes a user interface, a machine learning engine and system to store and retrieve data a required by the machine learning system.

In another aspect, a method for styling based on a user wardrobe includes:
learning user styles based on the user wardrobe;
learning third party styles based on third party wardrobes;
receiving current fashion trends;
identifying third party having similar user styles; and
recommending clothing to wear based on the current fashion trends and third party styles to the user wardrobe.

Implementations of the above aspects may include one or more of the following. The system can locate similar wardrobes, in aggregate, to make suggestions on what to wear or purchase to follow current styles or trends. The system can add new clothing purchases from a store into the user wardrobe. The system can download characteristics of the new clothing from the store. The system can take pictures of each item from the user wardrobe and performing size and color determination from the pictures.

The system can identify a manufacturer from the item and locating clothing attributes from the manufacturer. The system can recommend today's outfit based on weather and third party styles. The system can recommend today's outfit based on weather and a selected fashion trend. The system can recommend today's outfit based on user fitness and third party styles. The system can recommend today's outfit based on user fitness and a selected fashion trend. The user fitness can be user weight, physical activity, and body temperature. The system can recommend today's outfit based on user location and third party styles. The system can recommend today's outfit based on user location and a selected fashion trend. The system can collect fashion data from a plurality of mobile devices, web services, and social media. The system can recommend clothing purchases matching or complimenting the user wardrobe. The system can recommend predetermined clothing items that do not match the user styles and further selected by third parties with similar user styles. The system can digitally render the recommended clothing to wear from the user's wardrobe. The system selects only items from the user's wardrobe and digitally renders the recommended clothing to wear from the user's wardrobe. The system can generate a suggested combination of clothing from a store and one item from the user wardrobe and as such includes digitally rendering the recommended clothing from the store and the user's wardrobe.

Other implementations of the above aspects can include one or more of the following:
The system could work better by adding more data to the system from devices owned by the user or other data or web services and social media that provide data similar to the following:
Contextual data about the user and his/her behavior and/or environments (i.e., personal weight, exercise, distance to work, body temperature)
Data on environmental factors like weather, physical locations can be applied to provide improved recommendations

Advantages of the system may include one or more of the following. The system helps people to dress the way they'd like without stress, worry, or time loss. The benefits may include:
Look like the user planned the wardrobe fitting—don't plan how the user looks
Increase user options by 80% by leveraging the user's entire wardrobe
Automatically compliment the outfits of friends and colleagues
Use people you admire for buying advice on how to match their style
Use address and calendar data to provide context for recommendations
Provide data from other smart devices to provide more accurate suggestions

### BRIEF DESCRIPTION OF THE DRAWINGS

The invention can be more fully understood by reading the subsequent detailed description and examples with references made to the accompanying drawings, wherein:

FIG. 1 shows an exemplary learning system for fitting clothing, shoes, or gloves, among others.

FIGS. 2A-2C show a stylized block diagram of features of one embodiment of the preferred system.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

The advent of the Internet and subsequent development of eCommerce websites has led users to be able to shop for any desired item round the clock on any given day of the week. Accordingly, some online retailers have grown larger than some brick and mortar shops. In fact, in some categories of goods, such as, electronics or content such as ebooks, music, movies etc. online vendors can provide instant wish fulfillment to users. With the advent of better imaging technologies and increasing bandwidth availability via various networks consumers are also purchasing wearable items like clothing, jewelry, shoes or other accessories online via eCommerce websites. Regardless of how a consumer purchases a wearable item like clothing or other accessory, in order to determine how the item fits him/her, the consumer needs to try on the wearable item physically. In order to determine the combinations of items that would look good when worn together, the consumer needs to try on the various clothing or accessories together. This can be very time consuming if the right combination cannot be determined quickly. Moreover, when a consumer is in a physical store or purchasing a clothing item online, the consumer may not be able to determine accurately if the clothing item he/she is planning to purchase suits a garment that he/she already possesses since he/she may not have access to the garment at the time of purchase. In this situation it can be helpful if consumers have online access to a collection of digital versions corresponding to wearable items such as clothing or accessories that they may have in their wardrobes.

Embodiments disclosed herein relate to creating and accessing a digital wardrobe with a recommender system. In an embodiment, a collection of digital images of items purchased online via an eCommerce website can be stored in the user's account which can be accessed using a client device from any location via the Internet or a cellular network. Users can virtually try out various combinations of items in their digital wardrobe from a remote location at their leisure thereby saving them the time and effort of having to physically try out the wearable items in their real-world wardrobes. Moreover, if vendors also have access to the users' digital wardrobes it will enable them to recommend appropriate items that are personalized to each consumer's tastes based on the items in the consumer's wardrobe. Accordingly, embodiments are also included herein that pair a recommender system to the digital wardrobe which facilitates personalizing item recommendations for the users.

The following description is of the best-contemplated mode of carrying out the invention. This description is made for the purpose of illustrating the general principles of the invention and should not be taken in a limiting sense. The scope of the invention is best determined by reference to the appended claims.

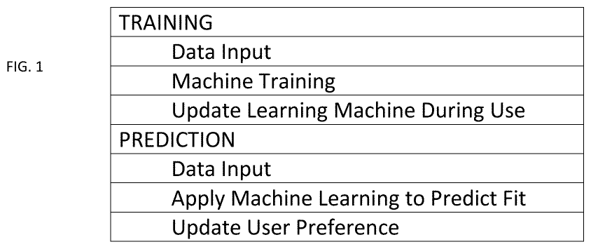

FIG. 1 shows an exemplary learning system for fitting clothing, shoes, or gloves, among others. The process has two phases: learning and live operation. The system is trained during the learning phase, and the system makes prediction based on the data input as applied to the learning machine to generate fitting predictions. Also, based on user feedback, the system can adaptively adjust its learning system to improve fit prediction performance. A high level pseudo-code for the clothing recommendation system is as follows:

TRAINING
Data Input
Machine Training
Update Learning Machine During Use

PREDICTION
Data Input
Apply Machine Learning to Predict Fit
Update User Preference

The recommendation makes suggestions:
On what outfit a user should wear based on what their wardrobe is made up of and other contextual elements like outside weather, the type of location a person will be wearing the outfit and other similar external factors.
Based on what other people will be wearing that day. The engine leverages a user's wardrobe to assess the style of the user in order to make suggestions on additional articles of clothing to purchase in order to expand their wardrobe.
On what clothing to purchase based on the articles of clothing in their own, or other user's digital closets.
   Additionally, if a user follows multiple people they can weigh how much a specific user should influence recommendations.
   A user could also set a specific followed user for recommendations on what to wear and a separate followed user for suggestions on what clothing to purchase (the latter used to build out new wardrobes in a different style to what a user currently owns).

In one embodiment, the user enters user height, weight, bra size, and age. The tool matches the user's body's dimensions to the garment, taking into account the fabric, style, sizing, and other variables. Then the style adviser gives the user the results, including best clothing to buy and how the item is likely to fit the user.

This solution can make outfit recommendations that are fashionably and contextually relevant to the user based on how their collection of clothing articles and accessories comprise a user's wardrobe and a subsequent personal sense of style. It can also generate detailed associations between the similarities of their wardrobe as compared to other users' wardrobes and how those users wear their clothing to make relevant suggestion on other ways to wear what they own or what items to purchase to expand their wardrobe.

Additionally, the system will compile the largest database of the actual clothing in a person's closet, which clothing from the closet are actually used, and the behavioral patterns to what combinations of clothing are worn together—and whether there are specific patterns that drive when something is worn (e.g., weather, season, geographical location, etc.). This can be used to make relevant and timely recommendations based on real-world, real-time trends for any scenario.

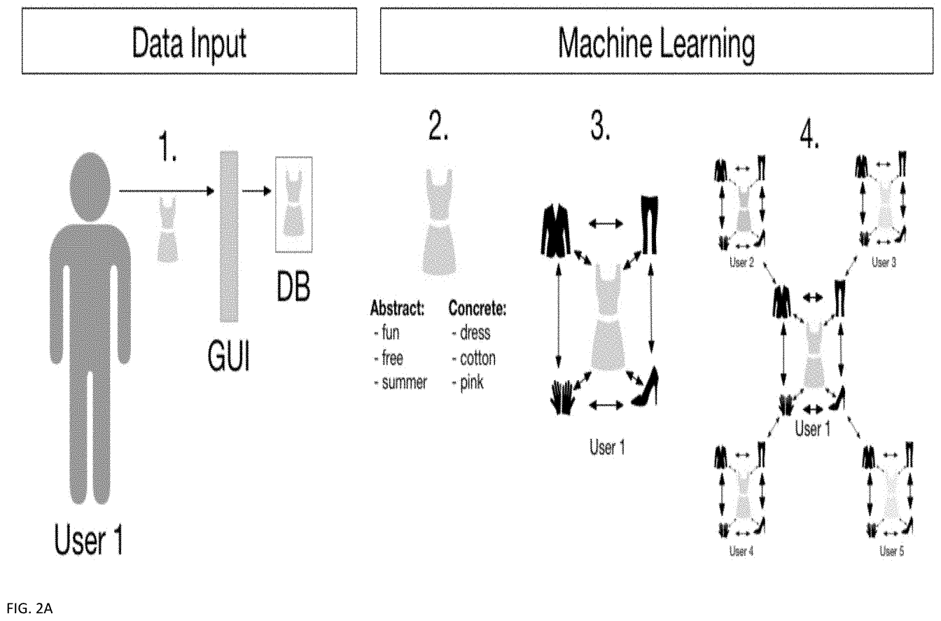

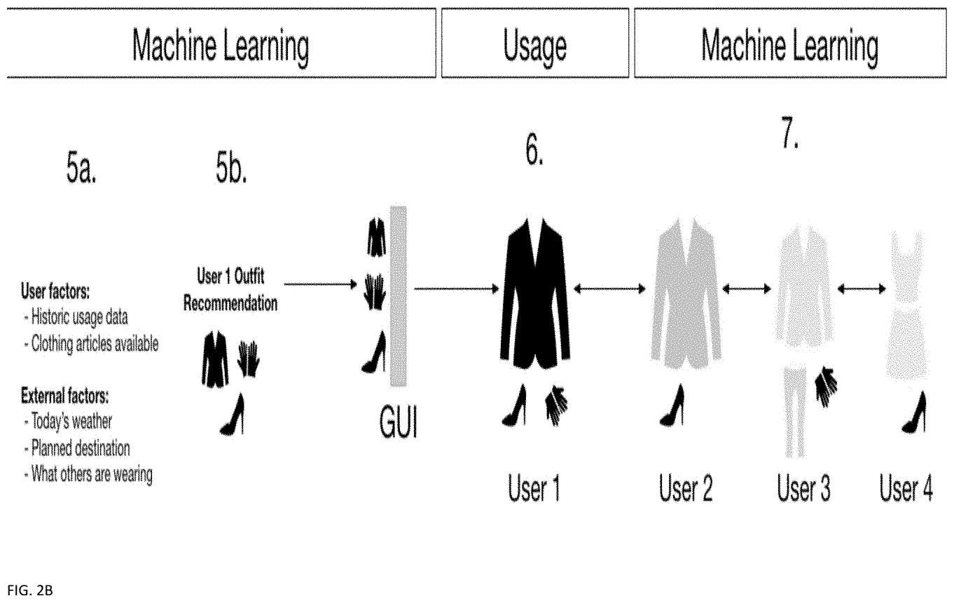

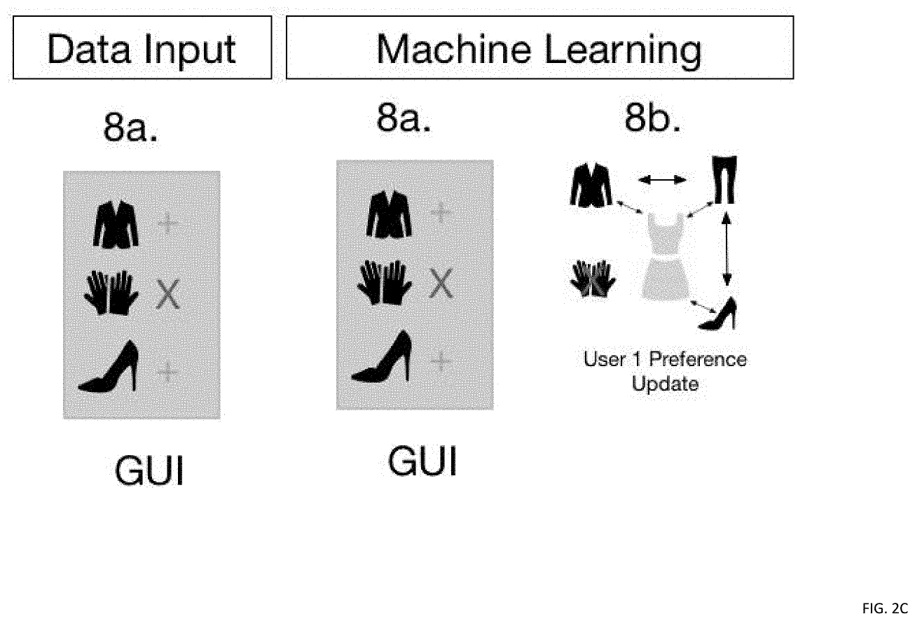

FIGS. 2A-2C show a stylized block diagram of features of one embodiment of the preferred system. Viewing FIGS. 2A-2C in combination, the following exemplary operations are performed:

1. Relevant data [clothing from closet] is entered into the system via some graphical user interface by the user
2. Concrete and abstract attributes are associated with each piece of data entered into the system
3. The system makes correlations between each item entered against all other items to identify ways to combine the items can be combined into something relevant and usable by the user.
4. The system makes correlations between the individual and collective articles of the user against the individual and collective articles of people with similarities.
5. The system leverages usage data of the user with other users plus external environmental and contextual data to make a recommendation on how to combine specific items into something useful for the time period expressed.
6. A user selects the items recommended and uses them during that specific time period.
7. The system assesses how the performance of the recommendation with other similar users to make better recommendations in the future.
8. The system assesses recommendations approved/used by the user and compares them with the decisions of other similar users to make recommendations of additional items the user should purchase.

The Components in FIGS. 2A-2C and associated functions are as follows:

### 1. Graphical User Interface

### 2. Database

3. Machine Learning or AI system
4. Individual items are entered into the system
5. Concrete and abstract attributes are associated with each piece of data entered into the system
6. The system makes correlations between each item entered by the user with every other items entered
7. The system makes correlations between the items entered with similar items entered by other users
8. The system collects external environmental and contextual data and makes correlations with potential combinations that can be recommended to the user.
9. The system make recommendations on how to combine specific items into something useful for a specific location or period of time
10. The user selects the individual items recommended use for the expressed location or period of time
11. The user rates the suggestion based on recommendations success
12. The system references combinations worn by the user to make future recommendations
13. The system references combinations worn by other users to make future recommendations
14. The system makes recommendations to additional items that could be purchased by the user

Thus, unlike other system that makes recommendations based on purchase history or by the user's connections to others, the system provides context on how people use and interact with the clothing available to them in their closets. Further, unlike other systems that can only make suggestions on which outfit to wear based on one complete outfit worn vs. another complete outfit worn—or based on general fashion trends, the present system makes recommendations based on the behavioral pattern of user. Additionally, they can only make purchase recommendations based on a user's purchase history or based on others users who have similar purchase behavior. Based on the data available, recommendations by the instant can take a user's complete wardrobe or the complete wardrobes of people similar to the user or users with similar wardrobes.

One embodiment provides a standard flow that follows: 4,5,6,7,8,9

Another embodiment provides a flow that follows: 4,9,10
1 is associated to 4,9,11,14
2 is associated with 4,5,6,7,8,10,11,12,13
3 is associated with 5,6,7,8,9,12,13,14
9 is associated with 5,6,7,8,12,13,14
14 can be achieved solely through 11 and/or 13

Preferably, the system makes recommendations based on what to wear based on:
the articles of clothing available (according articles have been entered)
items worn are removed from consideration according to a certain period of time or based on varying locations
if a user rates a specific outfit positively, then similar recommendations will be made to that user and others
if a user rates a specific outfit positively, new clothing purchase recommendations will the user or similar users
certain outfits will be recommended based on how they tie to external factors (i.e., warm day shorts; workday suits)
recommendations on what outfits to wear can be made to compliment what other are wearing

The system can use following using software programming and graphic design:
A graphical user interface that allows a user to input the clothing that they currently own
A data storage system to store and retrieve all user-inputted data, data collected from external sources (i.e., websites, social media, etc., data exhaust captured by the system, data extrapolated from all of the data held by the system,
A machine learning engine to make suggestions on what to wear to what to purchase based on the data available to it.

A user can recall and see all articles of clothing that make up their wardrobe. Without the system, people are limited by their memory to recall items from their wardrobe which leads to incomplete assessment of what is available; or their sight which can be obstructed by other articles of clothing in their closet, limiting their ability to make dressing decisions based on all articles of clothing available to them.

People will save time deciding what to wear as the preferred system will make relevant and contextual suggestions on what to wear for the day automatically, decreasing the amount time required to select something to wear; subsequently the preferred system will also remove any stress related to indecision in finding what to wear or suffering brought about by wearing outfits that that are not adequate for external factors like weather or social norms.

People will also save time on activities like shopping as the preferred systems can make relevant suggestion on what to purchase based their wardrobe, other people's wardrobes, or how the person or others are wearing clothing on a day-to-day basis.

The preferred system can be used in any field where a collection of items can be used to define a person's preferences and make suggestions on how to combine those items for some benefit. This solution can be applied to the:
Consumer
   Home decor
   Furniture
   Home appliance
   Automotive
   Consumer technology
   Job placement
Enterprise
   Mergers and Acquisitions
   Industrial equipment purchases
   Real estate
   Corporate insurance
   Automotive
   Advertising

The system can generate data products used by the following:
Retailers—who can leverage usage data to organize their stores to align with how people are wearing combinations for daily use
Brand/Fashion Designers—who can use data on what people are currently wearing to plan out what clothing to produce in an upcoming season
Third-party services providers who can leverage external data to create better profiles of their users (i.e. Linkedin using data from our recommendation engine to suggest how an interviewer should dress to increase the likelihood to win a specific job.

Exemplary operation of the learning system is detailed next.

### Training

(2) Data Input—Concrete metadata is used to categorize the garment, by attributing the related variables into the system in one of three ways. First, the user will photograph the garment using the mobile application. The mobile application will identify, then look up the specific item from a master clothing database using visual identification technology (such as visual computing). Second, for items that are missing from the master database (such as vintage garments), the user can photograph the garment and manually input the related variables (e.g., brand, size, item type, etc.). Third, the user can forward a digital copy of the receipt from the vendor, directly to their user account (connected to the user's dataset). The backend system will visually scan the receipt to identify and record the garment's associated SKU. The SKU will be used to source the related data from the original garment manufacturer and update it in the personal dataset. After the Concrete metadata is entered, the user may manually input additional Abstract metadata (e.g., fun, free, sexy, summer) and personal notes (e.g., “great for cocktail parties”).
(3) Machine Training/Learning—Initial matching recommendations are determined through the application of color and pattern theory, to construct rules-based complementary associations. Rules-based matching and machine learning (such as clustering analysis) will also be used to combine categories of clothing (for example correctly pairing a blouse with pants rather than a dress). The system will then associate concrete variables (e.g., color, pattern, cut) with abstract variables (e.g., personality, style, theme) to construct classifications.
FOR EXAMPLE: The system would not recommend a “summer dress” in winter. Or a pink suit for a funeral.

Recommendations are made from a combination of the user's personalized dataset, from items that a currently available in the user's personal inventory/closet, as well as other users' datasets (located on the cloud). The user can then accept or reject the recommended matches via the graphical user interface.

(6) & (7) Update Learning Machine During Use—As users interact with the system, they will generate engagement data (for example, as the user accepts or rejects recommended matches). Also, machine learning is applied to the combined personalized dataset and the engagement data to generate increasingly customized recommendations for the user. Historical usage, planned events (destinations or social engagements) and third-party contextual data sources (e.g., Today's weather) is referenced against the user's personalized data set to refine recommendations further.

### Prediction

(8) Data Input—All data from the training process is then referned and added to as a baseline for predictions.
Apply Machine Learning to Predict Fit—
Update User Preference
   FOR EXAMPLE: If the user has gained weight during the winter, the system can identify they've been wearing their comparatively larger sized pants. At any given point in time, the system will know the users exact size, from the items they are currently choosing to wear in their closet.

Additional Use Cases—This identification and recommendation engine can be used in a variety of other contexts and products. For example, a user could take a photograph of their living room and be provided with recommendations on new sofas, based on their other living room furniture, relevant variables (e.g., color, pattern, style, etc.), and sofas other users have selected who have similar taste.

While preferred aspects and example configurations have been shown and described, it is to be understood that various further modifications and additional configurations will be apparent to those skilled in the art. It is intended that the specific embodiments and configurations herein disclosed are illustrative of the preferred nature of the preferred system, and should not be interpreted as limitations on the scope of the preferred system. While various embodiments of the preferred system have been described above, it should be understood that they have been presented by way of example only, and not by way of limitation. Although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

All references cited herein are incorporated herein by reference in their entirety. To the extent publications and patents or patent applications incorporated by reference contradict the disclosure contained in the specification, the specification is intended to supersede or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term” “including’ should be read to mean “including, without limitation,’ “including but not limited to,’ or the like; the term “comprising” as used herein is synonymous with “including,” “containing,” or “characterized by,” and is inclusive or open-ended and does not exclude additional, unlisted elements or method steps; the term “having” should be interpreted as “having at least;” the term “includes’ should be interpreted as “includes but is not limited to;” the term “example” is used to provide exemplary instances of the item in discussion, not an exhaustive or limiting list thereof; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the preferred system, but instead as merely intended to highlight alternative or additional features that may or may not be utilized in a particular embodiment of the preferred system. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise.

With respect to the use of substantially any plural or singular terms herein, those having skill in the art can translate from the plural to the singular or from the singular to the plural as is appropriate to the context or application. The various singular/plural permutations may be expressly set forth herein for sake of clarity.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the preferred system to the specific embodiments and examples described herein, but rather to also cover all modification and alternatives coming with the true scope and spirit of the preferred system.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

Having fully described at least one embodiment of the present the preferred system, other equivalent or alternative methods of providing mobile cellular pods according to the present the preferred system will be apparent to those skilled in the art. The preferred system has been described above by way of illustration, and the specific embodiments disclosed are not intended to limit the preferred system to the particular forms disclosed. The preferred system is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method for styling based on a user wardrobe, comprising:
learning user styles based on the user wardrobe;
learning third party styles based on third party wardrobes;
receiving current fashion trends;
identifying third party having similar user styles; and
recommending clothing to wear based on the current fashion trends and third party styles to the user wardrobe.

2. The method of claim 1, comprising using similar wardrobes, in aggregate, to make suggestions on what to wear or purchase to follow current styles or trends.

3. The method of claim 1, comprising adding new clothing purchases from a store into the user wardrobe.

4. The method of claim 3, comprising downloading characteristics of the new clothing from the store.

5. The method of claim 1, comprising taking pictures of each item from the user wardrobe and performing size and color determination from the pictures.

6. The method of claim 5, comprising identifying a manufacturer from the item and locating clothing attributes from the manufacturer.

7. The method of claim 1, comprising recommending today's outfit based on weather and third party styles.

8. The method of claim 1, comprising recommending today's outfit based on weather and a selected fashion trend.

9. The method of claim 1, comprising recommending today's outfit based on user fitness and third party styles.

10. The method of claim 1, comprising recommending today's outfit based on user fitness and a selected fashion trend.

11. The method of claim 10, wherein the user fitness comprises user weight, physical activity, and body temperature.

12. The method of claim 1, comprising recommending today's outfit based on user location and third party styles.

13. The method of claim 1, comprising recommending today's outfit based on user location and a selected fashion trend.

14. The method of claim 1, comprising collecting fashion data from a plurality of mobile devices, web services, and social media.

15. The method of claim 1, comprising recommending clothing purchases matching or complimenting the user wardrobe.

16. The method of claim 1, comprising recommending predetermined clothing items that do not match the user styles and further selected by third parties with similar user styles.

17. The method of claim 1, comprising digitally rendering the recommended clothing to wear from the user's wardrobe.

18. The method of claim 1, comprising selecting only items from the user's wardrobe and digitally rendering the recommended clothing to wear from the user's wardrobe.

19. The method of claim 1, comprising generating a suggested combination of clothing from a store and one item from the user wardrobe.

20. The method of claim 19, comprising digitally rendering the recommended clothing from the store and the user's wardrobe.

21.
